(19) United States
(12) Patent Application Publication
(10) Pub. No.: US 2025/0150438 A1
(43) Pub. Date: May 8, 2025

(54) SYSTEMS AND METHODS FOR MONITORING THE SECURITY OF A COMPUTER SESSION

(71) Applicant: SecureReview, Inc., Pawling, NY (US)

(72) Inventor: Jordan ELLINGTON, Pawling, NY (US)

(21) Appl. No.: 18/730,083

(22) PCT Filed: Jan. 27, 2023
(86) PCT No.: PCT/US2023/061430

§ 371 Date: Jul. 18, 2024

Related U.S. Application Data
(63) Continuation of application No. 18/160,180, filed on Jan. 26, 2023, now abandoned.
(60) Provisional application No. 63/304,524, filed on Jan. 28, 2022.

(51) Int. Cl. H04L 9/40

(52) U.S. Cl. CPC H04L 63/0281; H04L 63/0861; H04L 63/1441

(57) ABSTRACT

Systems and methods are described for providing secure computer sessions using a dedicated browser. The dedicated browser is restricted to accessing a predefined set of one or more webpages. The dedicated browser accesses a respective webpage of the predefined set of one or more webpages through a respective proxy server of a set of one or more proxy servers. While accessing the respective webpage through the set of one or more proxy servers, the dedicated browser monitors whether a specified user is physically adjacent to the computer system using the camera and biometric information for the specified user. In accordance with a determination that the specified user is not physically adjacent to the computer system, the dedicated browser takes a remedial action (e.g., terminates access to the respective webpage).

### RELATED APPLICATION

This application is a continuation of U.S. application Ser. No. 18/160,180, filed Jan. 26, 2023, entitled “Systems and Methods for Monitoring the Security of a Computer Session,” which claims the benefit of the U.S. Provisional Application No. 63/304,524, filed Jan. 28, 2022, entitled “Systems and Methods for Monitoring the Security of a Computer Session,” each which is incorporated by reference in its entirety.

### TECHNICAL FIELD

The disclosed embodiments relate generally to secure computer systems, including but not limited to monitoring the security of a computer session through a browser. Some embodiments of the present disclosure also relate generally to multi-factor authentication, including but not limited to using an authentication status of a user from a secure session when the user attempts to log on to a different third-party system.

### BACKGROUND

Distributed workforces are quickly becoming the norm. As more work is done remotely, more sensitive data is becoming accessible via the internet and, concomitantly, there has been a recent explosion in the amount of data loss. Breaches and data loss may result in even larger damage to an organization's reputation. Thus, there is a need for systems and methods of preventing breach and data loss in a distributed workforce environment, both from internal and external threats. Further, there is a need for such systems and methods to be compatible with a variety of computing environments and operating systems (e.g., cross-platform), and accessible for non-technical users.

### SUMMARY

Some embodiments of the systems and methods described herein reduce or eliminate security concerns, while allowing users to work in a remote environment, through the use of a dedicated browser (e.g., web browser) that is restricted to accessing a predefined set of webpages. Further, the systems and methods described herein can be used to authenticate a user attempting to log in to a third-party system from a client device based on authentication data from a secure session initialized at the client device. In some embodiments, the secure session is initialized by a dedicated browser that is restricted to accessing a predefined set of webpages. In some embodiments, an authentication status associated with the secure session is communicated to a third-party system (e.g., associated with a different application), for example, as part of a multi-factor authentication scheme.

In accordance with some embodiments, a method is performed at a dedicated browser executing on a computer system comprising a camera and one or more processors and memory. The dedicated browser is restricted to accessing a predefined set of one or more webpages. The method includes accessing a respective webpage of the predefined set of one or more webpages through a respective proxy server of a set of one or more proxy servers. The method includes, while accessing the respective webpage through the set of one or more proxy servers, monitoring whether a specified user is physically adjacent to the computer system using the camera and biometric information for the specified user. The method includes, in accordance with a determination that the specified user is not physically adjacent to the computer system, taking a remedial action.

In accordance with some embodiments, a method is performed at a server system comprising one or more processors and memory. The method includes initiating a secure session of an application by: (i) receiving, from a client device, a first set of contextual data from a user interface presented by the client device, and (ii) determining, using the first set of contextual data from the application running on the client device, an authentication status of a user for the secure session. The method includes, while the secure session of the client device is active, determining that the user is attempting to log on, from the client device to a third-party system. The method includes communicating the authentication status of the user, for the secure session, to the third-party system.

In accordance with some embodiments, a computer system is provided. The computer system includes a camera, one or more processors, and memory. The memory stores one or more programs including a dedicated browser that is restricted to accessing a predefined set of one or more webpages, the dedicated browser including instructions for performing any of the methods described herein.

In accordance with some embodiments, a server system is provided. The server system includes one or more processors and memory. The memory stores one or more programs that include instructions for performing any of the methods described herein.

In accordance with some embodiments, a non-transitory computer-readable storage medium is provided. The non-transitory computer-readable storage medium stores one or more programs for execution by a computer system with one or more processors. The one or more programs comprise instructions for performing any of the methods described herein.

Thus, systems are provided with improved methods for monitoring the security of a computer session.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a system for providing secure computer sessions, in accordance with some embodiments.

FIG. 2 is a block diagram illustrating a computer system executing a dedicated browser, in accordance with some embodiments.

FIG. 3 is a block diagram illustrating an enterprise server (e.g., that provides secure computer sessions), in accordance with some embodiments.

FIG. 4 is a block diagram illustrating a third-party administrator server, in accordance with some embodiments.

FIGS. 5A-5B are schematic diagrams illustrating a method of providing secure computer sessions, in accordance with some embodiments.

FIG. 6 is a flowchart illustrating a method of providing secure computer sessions, in accordance with some embodiments.

FIGS. 7A-7B are schematic diagrams illustrating a method of using authentication data from a secure session, in accordance with some embodiments.

FIGS. 8A-8B are control flow diagrams illustrating methods for authenticating a user at a third-party system, in accordance with some embodiments.

FIGS. 9A-9B illustrate a flowchart of a method of providing authentication to a user, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

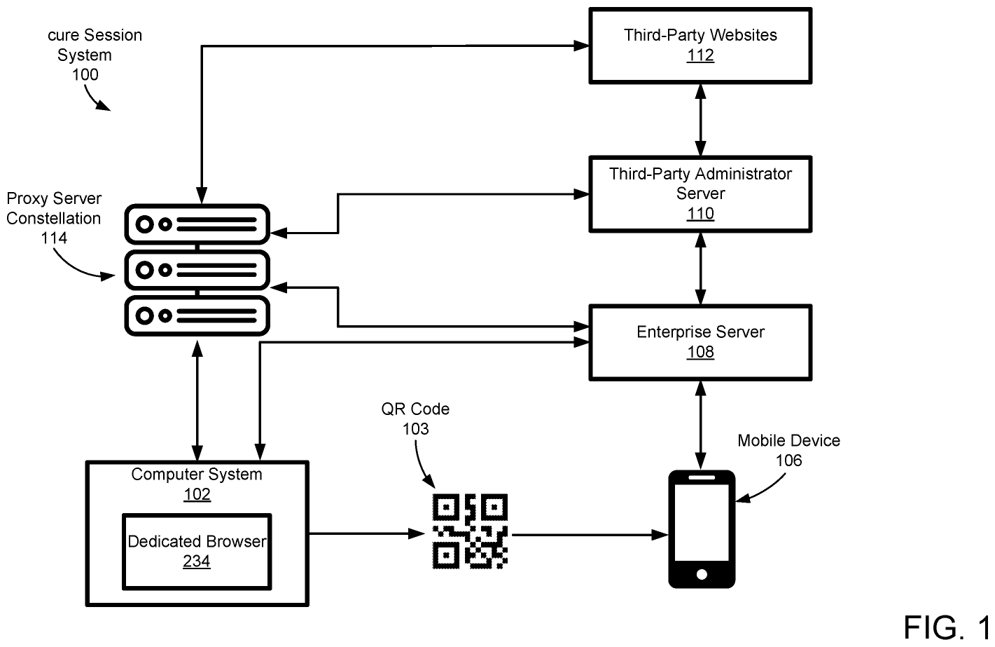

FIG. 1 is a block diagram illustrating a system for providing secure computer sessions (a secure session system 100), in accordance with some embodiments. In secure session system 100, an enterprise server 108 provides secure computer sessions as a service to a third party, represented by third-party administrator server 110. In some embodiments, a secure computer session is a mechanism through which a remote user can access data with a reduced or eliminated threat of breach (e.g., access by an unauthorized user) or data loss (e.g., transmission of data to unauthorized parties). In some circumstances, during a secure computer session (or simply “secure session”), a user of a client computer system (e.g., computer system 102) accesses data or information from one or more third-party websites 112 (e.g., restricted content items) and/or other third-party applications different from a website. Such websites and other third-party applications may belong to the third-party (e.g., the websites are the third-party's own websites). Further, in some embodiments, the third-party administrator server 110 is an administrator server at a web host of the one or more third-party websites 112. The session is secure in that the identity of the user is verified and actions have been taken to assure that the user alone is capable of accessing the data or information through that particular secure computer session. Such actions include performing continuous (e.g., periodic, polled) and/or one-time biometric authentication (e.g., as an additional authentication to access restricted content) to ensure that the user has not moved away from the computer system 102 without locking the computer system 102, verifying that the computer system 102 is running current antivirus software, detecting and/or blocking actions taken by the user that could remove information from the secure session (e.g., the user taking a screen shot and/or attempting to copy/paste text out of dedicated browser 234, as described in greater detail below), analyzing a video feed from a camera of computer system 102 to detect untoward behavior (e.g., detect the presence of a mobile phone, which could indicate that someone is attempting to take a picture of the screen, detect the presence of a second user within the field of view, which could indicate that the second user is “shoulder surfing”), etc. When the security of the data and/or information in the secure session is compromised, or could potentially be compromised, secure session system 100 takes remedial action (such as terminating access to the third-party websites 112 and/or blacking out the data and/or information displayed within dedicated browser 234). In some embodiments, the remedial action is taken in response to a user's request to access one or more restricted content items from an application running on (e.g., from) a third-party administrator server, and includes an additional biometric authentication that is distinct from the standard identification procedures associated with the secure session. In some embodiments, different remedial actions can be taken at the dedicated browser 234 and the third-party application.

As a more specific example, the third-party associated with third-party administrator server 110 may, in various circumstances, be a company, law firm, non-profit, government agency, or other organization. For ease of explanation, this example will consider a company. The company may want to allow employees to work remotely by logging into the company's website (e.g., third-party website 112), which could be a cloud-based collaboration portal, a document management portal, etc. Moreover, the company may wish to allow employees to access work-related materials from the employees' own devices. Such work-related materials can include one or more restricted content items (e.g., confidential and/or attorney-client privileged documents) that require additional access conditions to be met in order to for employees to access them. Unlike a corporate environment, in which any device issued to a user can be locked down and updated based on administrator policies, a user's personal device is free from many of the enterprise-level cybersecurity controls standard with company-issued laptops, tablets and smartphones. Additionally, users working remotely from a secure environment (e.g., a home office with a local network server) are typically removed from traditional security measures of such systems, as well as the physical security features of the environment (e.g., card access doors, on-site security to ensure authorized access, etc.). In this situation, the company may have a variety of security concerns. A malicious actor could steal the log-in name and password of one of the company's employee's and attempt to access the company's website. The data on the company's website may be quite sensitive, and the company may worry that their employees may not take appropriate care in safeguarding the data (e.g., by working from a coffee shop or train that provides only a public network with minimal security restrictions, or showing data to friends and family members). Through persistent and continuous security monitoring, the disclosed embodiments obviate or alleviate these concerns by ensuring that the correct user and only the correct user is accessing the company's webpage and that the user is not engaging in any in unscrupulous behavior (e.g., taking screen shots). These services are provided to the third-party by the enterprise server 108, and/or by dedicated browser 234.

To that end, in some embodiments, the enterprise server 108 receives registration information for a specified user, including, e.g., the specified user's email address. In some embodiments, the user registers him or herself, associating him or herself with a particular third-party that uses the service, and the enterprise server 108 optionally requests approval for the registration from the third-party administrator server 110. In some embodiments, the third-party administrator server 110 registers the user and provides the user's email address (or other form of communication). The enterprise server then provides, to the computer system 102 (e.g., via the user's email address), a link to download a dedicated browser 234. As described in greater detail below, dedicated browser 234 is a modified browser that is restricted to accessing only a predefined set of webpages. The predefined set of webpages are generally not defined by the user, but are instead defined by the third-party administrator (e.g., based on global configurations, security group configurations, or user profile configurations that are configured by the third-party administrator). Note that, in some circumstances, the term “predefined” means defined before or at the beginning of a secure computing session by accessing the aforementioned configurations. For example, the predefined set of webpages is generally not “hardwired” into the dedicated browser 234. Nevertheless, in some embodiments, the user may not change the predefined set of webpages (e.g., through browser settings).

In some embodiments, one or more predefined remedial actions are taken by the dedicated browser 234. In some embodiments, the dedicated browser has an API corresponding to a subset of the predefined remedial actions. In some embodiments, the same API or a different API can be used to cause the dedicated browser 234 to perform one or more of a set of predefined authentication techniques (e.g., through a call to the API). In some embodiments, the dedicated browser 234 is configured to store an identity provider chain.

After using the link to download the dedicated browser 234, the user is able to initiate a secure computer session by launching the dedicated browser 234. Launching the dedicated browser 234 optionally results in a variety of initial security checks, including a check to verify that antivirus software is running (e.g., via an application programming interface (API) call to the computer system 102's operating system), a check to verify that necessary security patches are up-to-date, a check to verify that data is being transmitted with appropriate encryption, and an initial identity verification. In some embodiments, the initial identity verification includes multi-factor authentication (MFA). In some embodiments, as part of initializing the dedicated browser 234, the dedicated browser displays a QR code 103 and prompts the user to take a picture of the QR code 103 with their mobile device 106. The mobile device 106 then sends the QR code 103 to enterprise server 108, which communicates with mobile device 106 to receive images and/or video from mobile device 106's camera. The images and/or video is used for an initial biometric authentication, e.g., by comparing the user in the images and/or video to biometric information for the user (e.g., a stored photo of the user that was provided during registration, which the enterprise server 108 looks up using the received QR code). Although, as described below, some embodiments perform continuous biometric authentication using video and/or images from computer system 102's camera, the initial biometric authentication via mobile device 106's camera provides a high-level of security because mobile devices typically have a higher resolution and are of higher quality than, for example, laptop webcams. In addition, this form of MFA is more secure than, for example, passing a six-digit access code to mobile device 106 for the user to enter at computer system 102 because it may be the correct user that is trying to circumvent the security features. For example, a company's employee may have asked their spouse to log-in to their account from computer system 102, and could pass along the six-digit access code as well. In contrast, the process described above, although optional, provides added security to ensure that the person who scanned the QR code 103 is actually the person using computer system 102.

In some embodiments, mobile device 106 is a smart-phone, tablet, or the like. In some embodiments, any device having a camera with a higher resolution than the camera of computer system 102 may be used in place of and in an analogous manner to mobile device 106.

If the initialization is successful, the dedicated browser 234 is able to access third-party websites 112 through a proxy server in proxy server constellation 114. (If the initialization is unsuccessful for whatever reason, access to the third-party websites 112 is typically denied and the cause for the unsuccessful initialization may be recorded by enterprise server 108, e.g., for subsequent audits). While the dedicated browser 234 accesses the third-party websites 112, a variety of security criteria may be continuously and/or periodically monitored, including continuous and/or intermittent (e.g., one-off and/or periodic) biometric verification. In addition, in some embodiments, the dedicated browser 234 passes information identifying the user to the proxy server, which can pass the information identifying the user to the third-party administrator. Either the proxy server or the third-party administrator can query (e.g., poll) the user's status, using the identifying information, to verify that the putative user accessing the third-party website is actually logged into enterprise server 108's service (e.g., to defeat spoofing). When the security criteria are not met, or the user is not logged into enterprise server 108's service, an appropriate remedial action is taken. The appropriate remedial action may depend on the sensitivity of the data and/or the nature and/or severity of the security violation. For example, a user walking away from their terminal may result in a countdown timer, at the end of which, access to the third-party website is terminated. In contrast, when a cell phone is pointed at the computer system 102's display is detected, the dedicated browser 234 may immediately black out and/or otherwise obscure the content of the third-party website (because a countdown timer would provide plenty of time for someone to take a photograph of the display).

In addition, as should be clear from the description above, different computer systems shown in FIG. 1 may detect security violations. For example, if third-party administrator server 110 determines that the user is not logged into enterprise server 108's service, the third-party administrator may terminate access through the proxy server. Continuous biometric verification, on the other hand, may be performed at computer system 102, at enterprise server 108, or using a combination of the two. When one of these systems determines that the continuous biometric verification has failed, that system may take remedial action. As will be discussed below, in some embodiments, an identity provider chain is created between two or more systems shown in FIG. 1, wherein the identity provider chain includes authentication data provided by the user to either of the systems. In some embodiments, the identity provider chain causes a system to take a remedial action based on a failure to authenticate a user by another system of two or more systems that is associated with the identity provider chain.

Note that the communication shown in FIG. 1, with the exception of mobile device 106 taking a picture of QR code 103, is typically carried out using HTTPS (port 443).

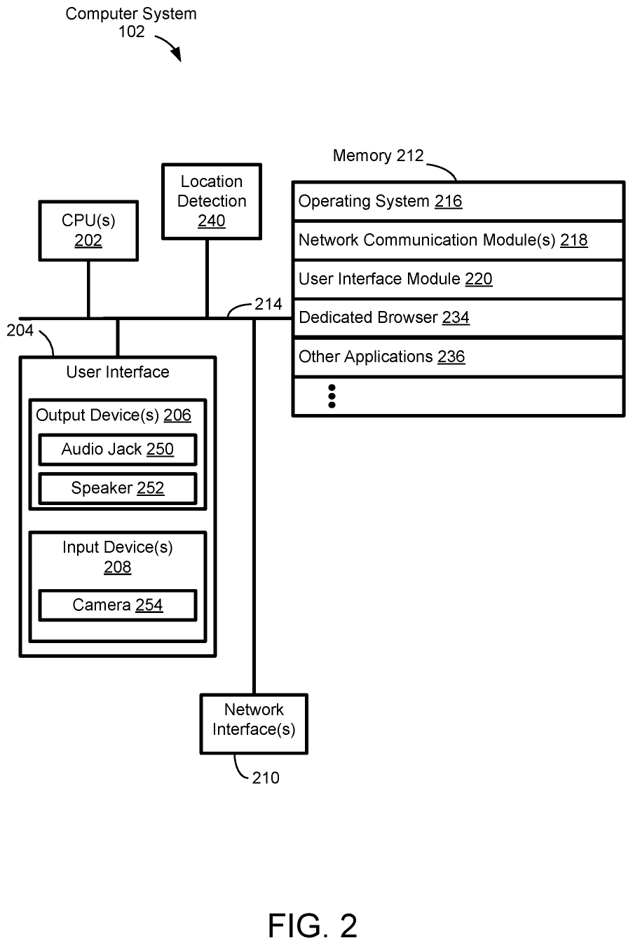

FIG. 2 is a block diagram illustrating computer system 102 executing dedicated browser 234, in accordance with some embodiments.

The computer system 102 includes one or more central processing units (CPU(s), i.e., processors or cores) 202, one or more network (or other communications) interfaces 210, memory 212, and one or more communication buses 214 for interconnecting these components. The communication buss 214 optionally include circuitry (sometimes called a chipset) that interconnects and controls communications between system components.

In some embodiments, the computer system 102 includes a user interface 204, including output device(s) 206 and/or input device(s) 208. In some embodiments, the input devices 208 include a keyboard, mouse, or track pad. In some embodiments, input devices 208 include a camera 254 (e.g., a webcam) that captures images within a field of view adjacent to the computer system 102. Alternatively, or in addition, in some embodiments, the user interface 204 includes a display device that includes a touch-sensitive surface, in which case the display device is a touch-sensitive display. In computer systems that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Optionally, the computer system 102 includes an audio input device (e.g., a microphone) to capture audio (e.g., speech from a user). The speech from the user is used, in accordance with some embodiments, to perform voice authentication.

Optionally, the computer system 102 includes a location-detection device 240, such as a global navigation satellite system (GNSS) (e.g., GPS (global positioning system), GLONASS, Galileo, BeiDou) or other geo-location receiver, and/or location-detection software for determining the location of the computer system 102 (e.g., a module for finding a position of the computer system 102 using trilateration of measured signal strengths for nearby devices).

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the computer system 102 to other computing devices;
a user interface module 220 that receives commands and/or inputs from a user via the user interface 204 (e.g., from the input devices 208) and provides outputs for, e.g., display on the user interface 204 (e.g., the output devices 206);
a dedicated browser 234 for accessing, viewing, and interacting with websites during a secure computer session. In some embodiments, as explained elsewhere in this document, the dedicated browser 234 is restricted to accessing only a predefined set of webpages; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, etc.

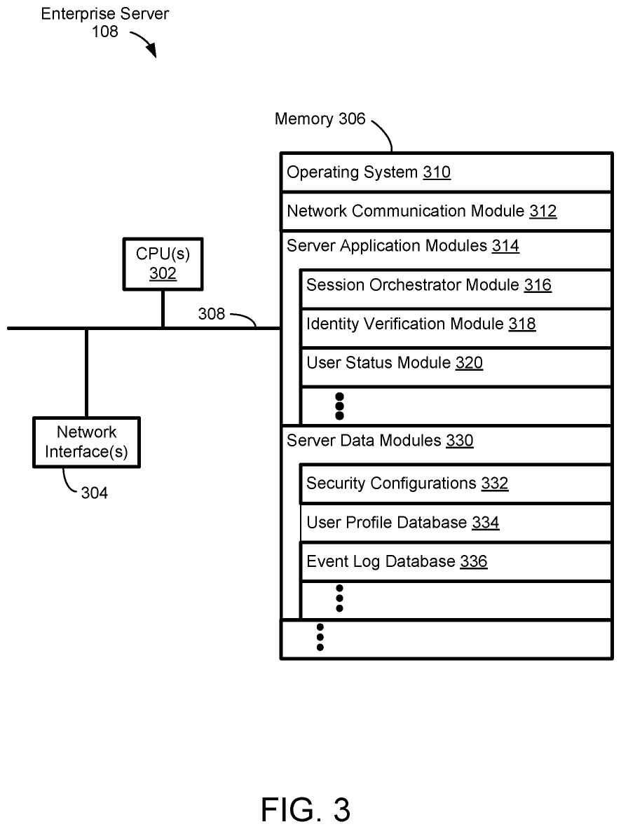

FIG. 3 is a block diagram illustrating an enterprise server 108, in accordance with some embodiments. The enterprise server 108 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting other computing devices via one or more network interfaces 304 (wired or wireless);
one or more server application modules 314 for performing various functions with respect to providing and managing a content service, the server application modules 314 including, but not limited to, one or more of:
   a session orchestrator module 316 that receives log-in requests from client computer systems (e.g., log-in requests from dedicated browsers 234 running on computer systems 102), passes user-based configurations to the client devices, and otherwise orchestrates secure computer sessions for the client computer systems (e.g., through dedicated browsers 234);
   an identity verification module 318 that, e.g., performs an initial identity verification by communicating with a mobile device of a specified user and performing a biometric analysis using images obtained by the mobile device; and
   a user status module 320 for responding to requests (e.g., from a proxy server or third-party administrator) for the log-in status of the user.
one or more server data module(s) 330 for handling the storage of and/or access to data relating to the provision of secure computer sessions; in some embodiments, the one or more server data module(s) 330 include:
   security configurations 332 including global configurations (e.g., applicable to all users for a particular third-party) and security group configurations (e.g., applicable to groups of users for a particular third-party, such as a “human resources” group for a particular company or agency that maintains secure computer sessions through the services provided by enterprise server 108). In some embodiments, the configurations include lists of websites that applicable users are permitted to access and/or lists of proxy servers through which applicable users are permitted to access such websites;
   a user profile database 334 for storing profiles for users (e.g., for whom secure computer sessions are provided). In some embodiments, the user profiles include lists of websites that users are permitted to access and/or lists of proxy servers through which applicable users are permitted to access such websites. In some embodiments, the user profiles include biometric information for the user (e.g., a photograph, a voiceprint, a finger print, a retinal scan, etc.); and
   an event log database 336 for storing a log of security events (e.g., as described elsewhere) in association with particular users (e.g., so that a security audit can be performed at a later time, or a report can be provided to a third-party administrator).

In some embodiments, the enterprise server 108 includes web or Hypertext Transfer Protocol (HTTP) servers, File Transfer Protocol (FTP) servers, as well as webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript, and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the enterprise server 108 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the enterprise server 108, and how features are allocated among them, will vary from one implementation to another and, optionally, depends in part on the amount of data traffic that the server system handles during peak usage periods as well as during average usage periods.

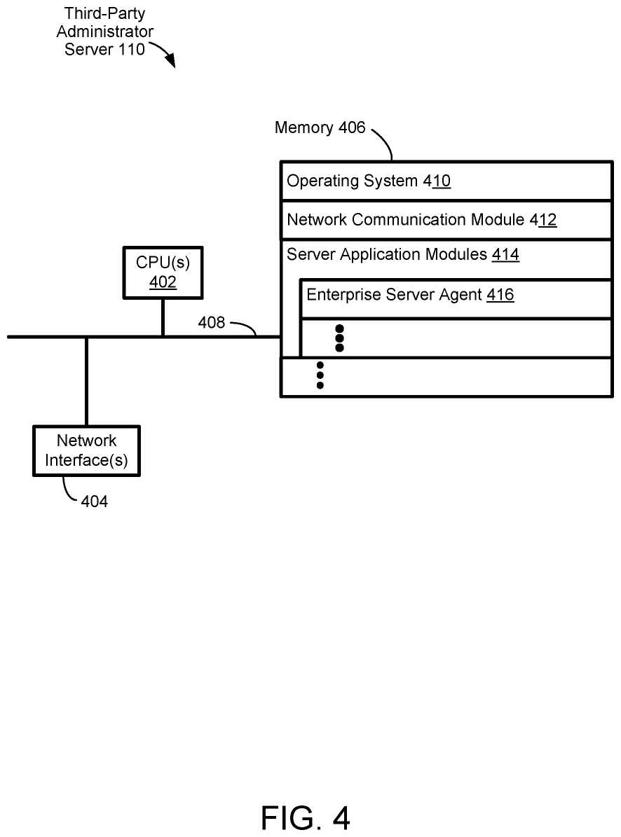

FIG. 4 is a block diagram illustrating a third-party administrator server 110, in accordance with some embodiments. The third-party administrator server 110 typically includes one or more central processing units/cores (CPUs) 402, one or more network interfaces 404, memory 406, and one or more communication buses 408 for interconnecting these components.

Memory 406 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 406 optionally includes one or more storage devices remotely located from one or more CPUs 402. Memory 406, or, alternatively, the non-volatile solid-state memory device(s) within memory 406, includes a non-transitory computer-readable storage medium. In some embodiments, memory 406, or the non-transitory computer-readable storage medium of memory 406, stores the following programs, modules and data structures, or a subset or superset thereof:
an operating system 410 that includes procedures for handling various basic system services and for performing hardware-dependent tasks;
a network communication module 412 that is used for communicating with other computing devices via one or more network interfaces 404 (wired or wireless);
one or more server application modules 414, but not limited to, one or more of:
   an enterprise server agent 416 for communicating with enterprise server 108, and, in particular, for requesting user-status information (e.g., information as to whether a particular user is logged into enterprise server 108's system).

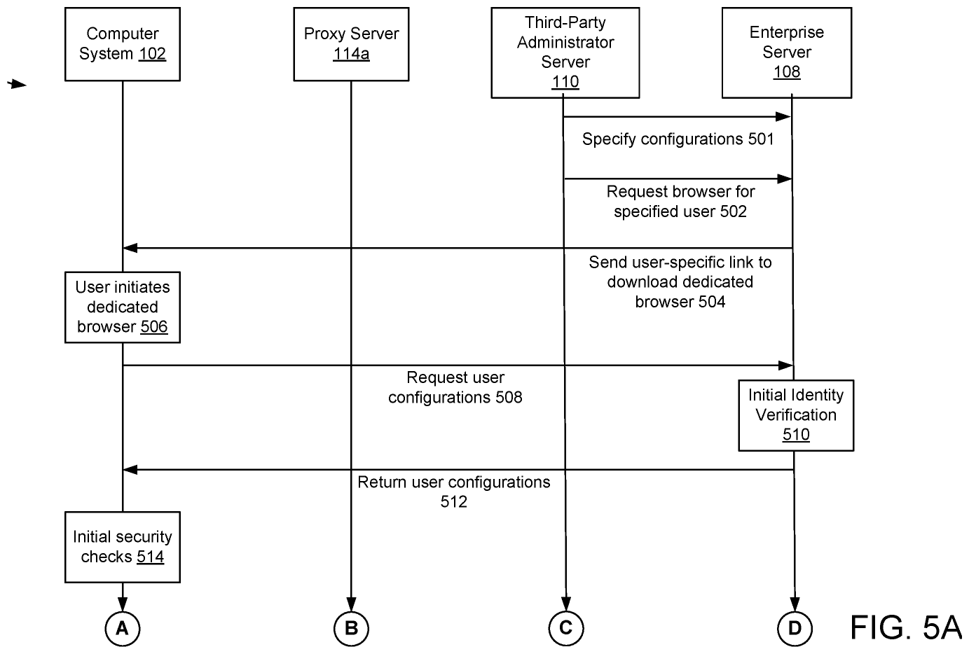

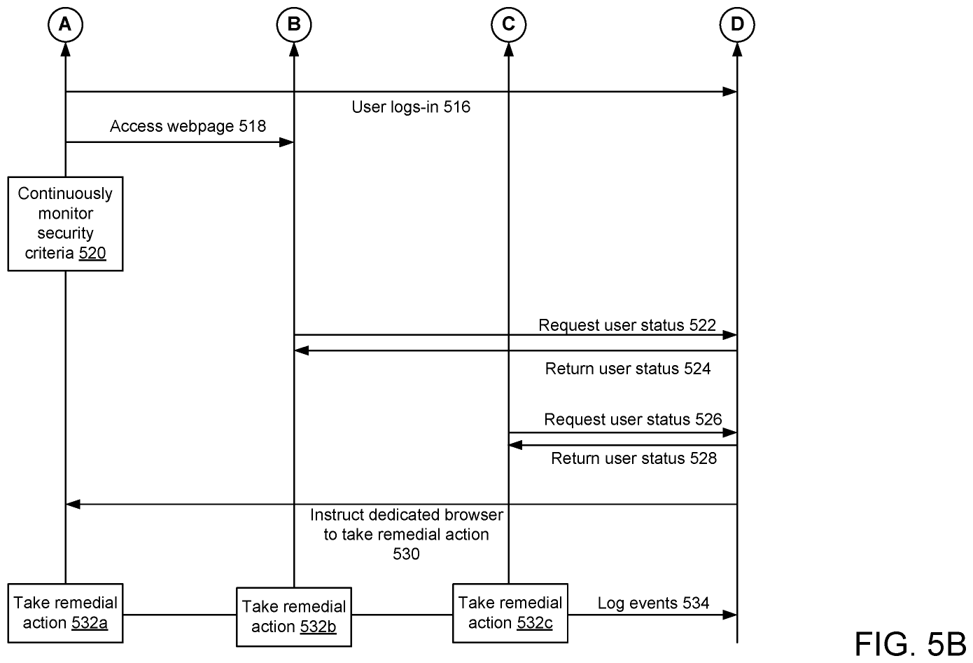

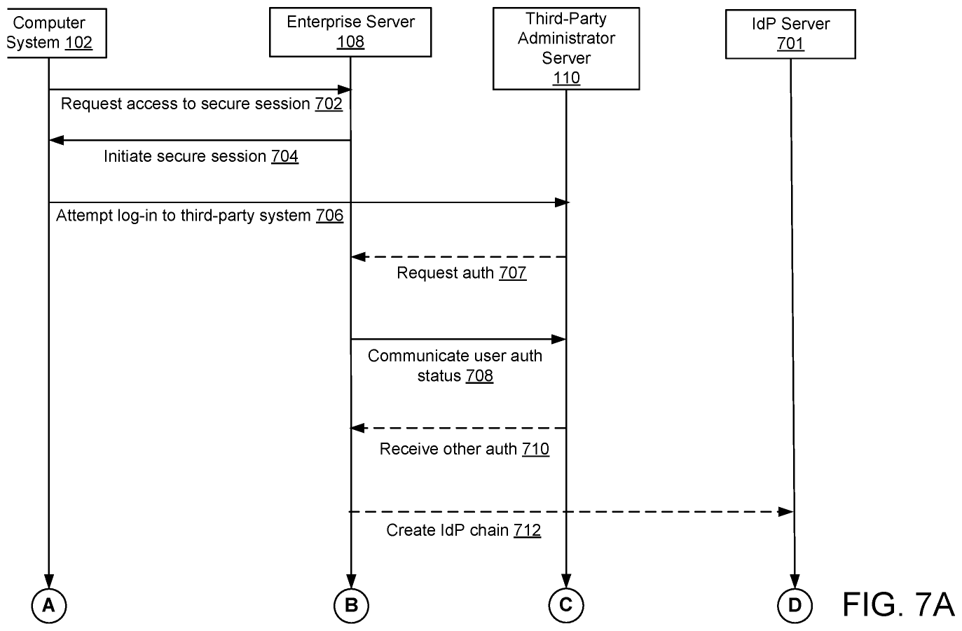

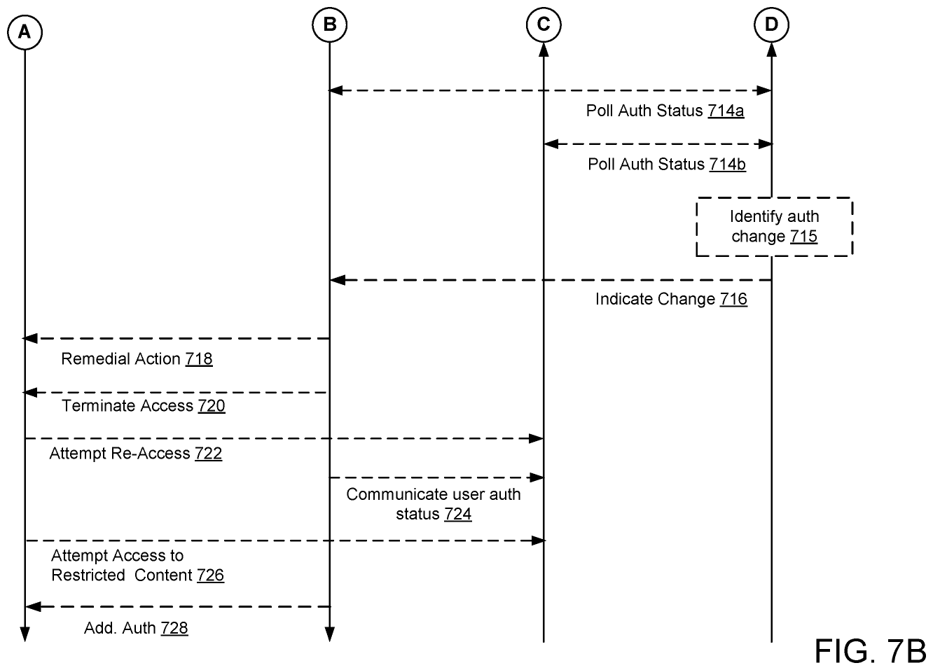

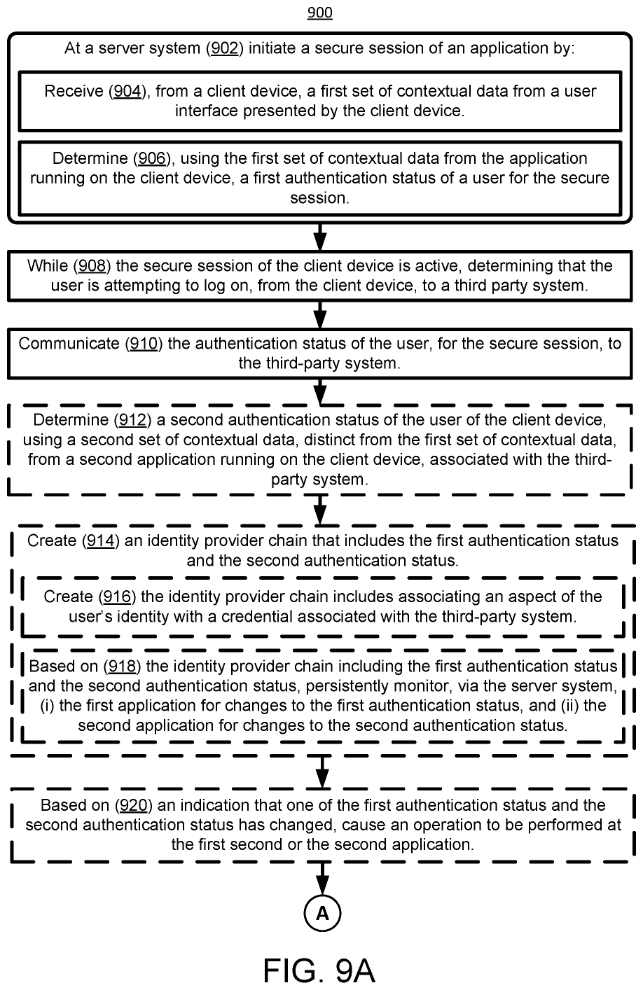

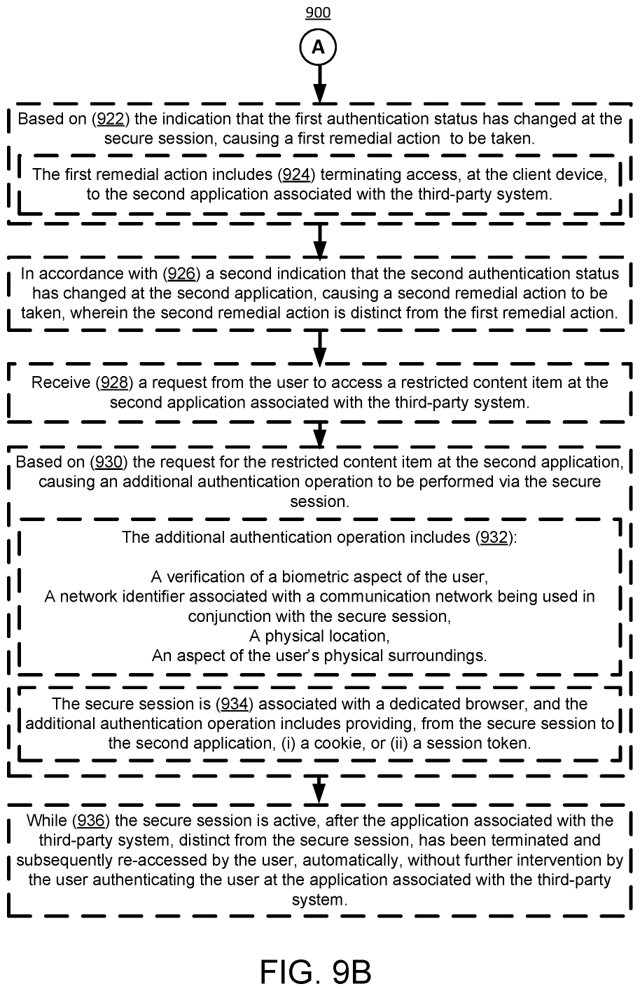

FIGS. 5A-5B are schematic diagrams illustrating a method 500 of providing secure computer sessions, in accordance with some embodiments. Method 500 provides an example of communication between various devices shown and described with respect to FIG. 1, and the order of operations between them. Note, however, method 500 is just one example of the communication between the various devices, while other examples are described through this specification and/or will be apparent to one of skill in the art. Further, in some embodiments, one or more of the operations of the method 500 can be performed in conjunction with any of the operations of the method 700 described with respect to FIGS. 7A-7B, and/or the method 900 described with respect to FIGS. 9A-9B.

In method 500, third-party administrator server 110 specifies configurations (501) for secure computer sessions by transmitting configuration information to enterprise server 108, which orchestrates the secure computer sessions. The configurations can include global configurations (meaning “global” with respect to the third-party), security group configurations (e.g., configurations for various groups of employees of the third-party with different privileges and work requirements, such as, perhaps, a “human resources” group which includes employees within the third-party's human resources department), and user profiles (e.g., configurations for specific users). Note that, typically, third-party administrator server 110 is able to modify the configurations at any time in method 500.

Continuing with method 500, third-party administrator server 110 requests, from the enterprise server 108, a browser (502) (e.g., dedicated browser 234) for a specified user (e.g., an employee of the third-party). The request for the specified browser may include information allowing the enterprise server 108 to communicate with the specified user (e.g., an email address). In this example, the specified user is a user of computer system 102. In some embodiments, the dedicated browser is requested by the user (e.g., from the computer system 102), and the enterprise server 108 determines whether the user is associated with the third-party administrator server 110, and if so, which configurations apply.

Continuing with method 500, enterprise server 108 sends a user-specific link to download dedicated browser (504). In some embodiments, the link can only be used once (e.g., the dedicated browser can only be installed, for that user, on a single computer system). The specified user uses the link to install the dedicated browser on the computer system 102.

Thereafter, the user initiates the dedicated browser (506). Upon or shortly after initiation of the dedicated browser, the dedicated browser requests user configurations (508) from the enterprise server 108, which may include global configurations, security group configurations for security groups to which the user belongs, and configurations from the user's own profile. In some embodiments, the configurations are determined by the enterprise server upon receiving the request (e.g., the configurations are determined at run-time of the dedicated browser). In addition to determining the configurations, an initial set of security checks may be performed, including security checks performed by the dedicated browser (514) (e.g., checking that antivirus software is up-to-date and running) and security checks performed by the enterprise server (e.g., an initial identity verification (510), as described elsewhere in this document). The enterprise server returns the user configurations (512). If any of the initial security checks fail, either the dedicated browser or the enterprise server will block the secure session from initiating.

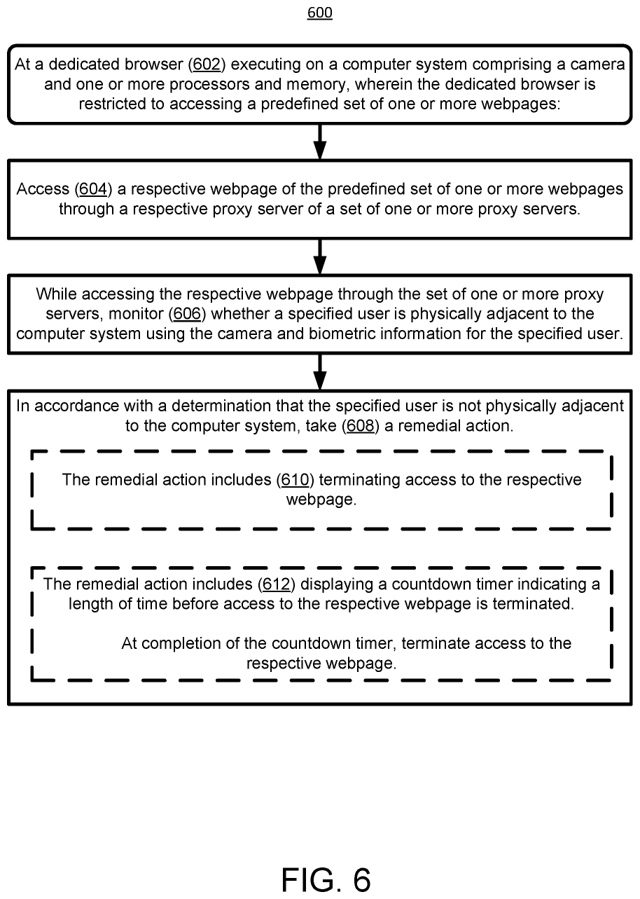

If the initial security checks are successful, the user is logged-in (516) to the service provided by the enterprise server 108. While logged-in, the user may use the dedicated browser to access webpages through a proxy server 114a (e.g., a proxy server within proxy server constellation 114, FIG. 1), thus initiating a secure computer session. Further details regarding the dedicated browser accessing webpages through a proxy server are provided throughout this document, including with respect to FIG. 1 and FIG. 6. During the secure computer session, the browser continuously monitors (520) a variety of security criteria, including, e.g., continuously performing biometric verification by comparing images obtained by computer system 102's webcam to a photograph of the specified user stored in the specified user's profile at enterprise server 108. Note that, in various embodiments, the enterprise server 108 may assume some or all of the continuous monitoring of the security criteria (e.g., images and/or video from computer's system 102 are sent to enterprise server 108 for the aforementioned comparison). When the security criteria fail, the dedicated browser 234 takes remedial action (532a) (e.g., blacking out the content displayed in the browser, terminating access, terminating the secure computer session, displaying a countdown timer to indicate when access or the secure session will be terminated).

During the secure session, to prevent spoofing, proxy server 114a may request (522) the user's status (e.g., with the status being one of “logged in” or “not logged in”) from enterprise server 108. The enterprise server 108 returns (524) the user's status. The proxy server 114a can use the user's status to take remedial action (532b), e.g., by terminating access to the webpage.

In an analogous manner, third-party administrator server 110 may request (526) the user's status (e.g., with the status being one of “logged in” or “not logged in”) from enterprise server 108. The enterprise server 108 returns (528) the user's status. The third-party administrator server 110 can use the user's status to take remedial action (532c), e.g., by terminating access to the webpage.

The remedial actions taken by the dedicated browser, the proxy server 114a, and/or the third-party administrator server 110 are logged as security events (534) with the enterprise server 108, which stores the events in event log database 336 for future auditing.

Although FIGS. 5A-5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive.

FIG. 6 is a flow diagram illustrating a method 600 of monitoring the security of a computer session through a browser, in accordance with some embodiments. Method 600 may be performed at a dedicated browser (602) (e.g., dedicated browser 234) executing on a computer system comprising a camera (e.g., camera 254 of computer system 102, FIG. 2) and one or more processors (e.g., CPU(s) 202, FIG. 2) and memory (e.g., memory 212, FIG. 2). In some embodiments, the dedicated browser is restricted to accessing a predefined set of one or more webpages (e.g., restricted to accessing only the predefined set of one or more webpages, such that the dedicated browser cannot access any webpages that are not within the predefined set of one or more webpages). Thus, in some embodiments, the dedicated browser is restricted to accessing only a whitelist of webpages.

The dedicated browser accesses (604) a respective webpage of the predefined set of one or more webpages through a respective proxy server of a set of one or more proxy servers. In some embodiments, the access to the respective webpage does not require a virtual private network (VPN).

While accessing the respective webpage through the set of one or more proxy servers, the dedicated browser monitors (606) (e.g., continuously monitors, and/or continuous (e.g., periodically) to monitor while accessing the respective webpage) whether a specified user is physically adjacent to the computer system using the camera and biometric information for the specified user.

In some embodiments, the dedicated browser monitors (e.g., continuously monitors, and/or continuous (e.g., periodically) to monitor while accessing the respective webpage) a plurality of security criteria, wherein the plurality of security criteria include a criterion that is met when the specified user is physically adjacent to the computer system. In some embodiments, the plurality of security criteria include a criterion that fails to be met when another user that is not the specified user is within the field of view of the camera (e.g., when there is potentially another user looking over the specified user's shoulder). In some embodiments, the plurality of security criteria include a criterion that fails to be met when a phone, external camera, or other electronic device is detected within the field of view of the computer system's camera (e.g., the dedicated browser detects when someone may be trying to take a picture of the computer system's display). In some embodiments, the plurality of security criteria include a criterion that fails to be met when a VPN is detected (e.g., the specified user is allowed to access the set of one or more webpages only from a particular location or region, and thus the dedicated browser detects when the specified user is attempting to access the respective webpage using a VPN so as to appear as though the traffic is coming from the particular location or region).

In some embodiments, monitoring whether the specified user is physically adjacent to the computer system includes continuous identity verification (e.g., using a photograph of the specified user from a user profile of the specified user). In some embodiments, monitoring whether the specified user is physically adjacent to the computer system includes determining that the specified user meets liveness criteria (e.g., that the specified user is moving, blinking, etc., to ensure that the continuous monitoring is not being fooled by, e.g., a photograph of the specified user being held up to the camera).

In some circumstances, the monitoring described herein is considered “continuous” when determinations as to the security criteria are made at predefined intervals that are short enough to prevent breach or data loss (which may depend on the security criteria being monitored). For example, when monitoring the user's presence at the computer system, it may be sufficient to determine that the user is present once every second, or even every few seconds. On the other hand, to prevent a user from quickly raising a camera (e.g., mobile phone) and taking a picture of the screen, such monitoring should be performed at intervals of under one second. Thus, the monitoring described herein is described as continuous when determinations as to the security criteria are made every hundred milliseconds, every second, every five seconds, or every ten seconds, or at some other appropriate interval. In some embodiments, the monitoring described herein is continuous when determinations as to the security criteria are made using, e.g., every image received from the camera of the computer system. Certain criteria, such as detecting an attempted screenshot, can be monitored continuously without regard to any interval.

In some circumstances, the dedicated browser determines that the specified user is not physically adjacent to the computer system (e.g., without the computer system being locked). In accordance with a determination that the specified user is not physically adjacent to the computer system, the dedicated browser takes (608) a remedial action (e.g., without user intervention). In some embodiments, the dedicated browser determines whether the computer is locked, and, if the computer is locked, forgoes taking the remedial action notwithstanding the fact that the specified user is not physically adjacent to the computer system (e.g., the specified user is permitted to walk away from the computer system so long as the computer system is locked). In some embodiments, while the security criteria continue to be met, the dedicated browser forgoes the remedial action and continues to permit access to the respective webpage through the respective proxy server.

In some embodiments, the remedial action includes (610) terminating access to the respective webpage. In some embodiments, the remedial action includes terminating the session of the dedicated browser. In some embodiments, the remedial action includes obscuring content displayed in the dedicated browser. In some embodiments, the remedial action includes locking the computer system.

In some embodiments, the remedial action includes (612) displaying a countdown timer indicating a length of time before access to the respective webpage is terminated. At completion of the countdown timer, the dedicated browser terminates access to the respective webpage.

In some embodiments, the dedicated browser receives, from an enterprise server (e.g., at run-time, without user intervention, where run-time means at the launch of the dedicated browser or at least at the launch of the session): a list specifying the predefined set of one or more webpages to which the dedicated browser is configured to access; and identifiers of the set of one or more proxy servers through which the dedicated browser is configured to access the predefined set of one or more webpages.

In some embodiments, the list specifies websites, domains, or sub-domains, and the set of one or more webpages are specified by virtue of their membership in those websites, domains, or sub-domains. In some embodiments, the list specifying the predefined set of one or more webpages includes webpages from a single domain (e.g., the third-party administrator's domain). In some embodiments, the list specifying the predefined set of one or more webpages includes webpages from less than 3 domains, less than 5 domains, or less than 10 domains. In some embodiments, the list specifies a single domain. In some embodiments, the list specifying the predefined set of one or more webpages specifies one or more regular expressions for the webpages. Thus, if a webpage's URL matches one of the regular expressions in the list, the dedicated browser is able to access the webpage (e.g., the webpage is whitelisted).

In some embodiments, the dedicated browser selects the respective proxy server from the identified set of one or more proxy servers. In some embodiments, the enterprise server provides the identifiers of the set of one or more proxy servers in a list of proxy servers, wherein the list is ranked, e.g., based on expected latency (e.g., with lower latency proxy servers ranked higher in the list). In some embodiments, the identified set of proxy servers meet jurisdictional requirements. For example, a jurisdiction may require that certain network traffic remain within the jurisdiction. When such requirements are present, the enterprise server will provide a list of only proxy servers that are present within the jurisdiction.

In some embodiments, the list specifying the predefined set of the one or more webpages and/or the identifiers of the set of one or more proxy servers are generated and/or determined by the enterprise server in real-time (e.g., at run-time and/or upon initiation of a session of the dedicated browser). For example, the list specifying the predefined set of the one or more webpages may be specified using a variety of hierarchical group settings, including global configurations, security group configurations, and user profile configurations. At run-time, the enterprise server determines the list specifying the predefined set of the one or more webpages based on the global configurations, security group configurations for security groups to which the user belongs, and/or user profile configurations for the user profile.

In some embodiments, the dedicated browser receives (prior to accessing the respective webpage), from the enterprise server (e.g., at run-time, without user intervention), a temporary authentication credential that allows the dedicated browser to access webpages from the predefined set of one or more webpages through the set of one or more proxy servers. In some embodiments, accessing the respective webpage of the predefined set of one or more webpages through the respective proxy server of a set of one or more proxy servers includes providing the temporary authentication credential to the respective proxy server. The respective proxy server determines whether the temporary authentication credential is a valid authentication credential. In some embodiments, the proxy server passes the temporary authentication credential to the enterprise server, which determines the validity of the authentication credential and returns a result. In accordance with a determination that the authentication credential is a valid authentication credential, the respective proxy server allows access to the respective webpage. In accordance with a determination that the authentication credential is not a valid authentication credential, the respective proxy server does not allow access to the respective webpage.

In some embodiments, the temporary authentication credential is valid for a length of a session within the dedicated browser. In some embodiments, each session is provided (by the enterprise server) with a unique credential (e.g., a credential that is different from the credentials for other sessions). In some embodiments, the session begins when the specified user launches the browser or initiates a session within the browser by going through an initial set of security checks (e.g., including an initial identity verification). In some embodiments, the initial set of security checks includes a security check (e.g., through an API call to the operating system) to verify that the computer system has up-to-date virus detection software enabled. In some embodiments, the session ends when the specified user closes the browser. In some embodiments, the session ends when access to the respective webpage is terminated (e.g., because the specified user walked away from his or her workstation), at which point the specified user must re-initiate a new session to continue (e.g., by going through the initial set of security checks including an initial identity verification). In some embodiments, the enterprise server provides the temporary authentication credential in response to the dedicated browser successfully completing the initiation (e.g., including the security checks). In some embodiments, rather than using a temporary credential, the respective proxy server uses OAuth or a similar profile to authenticate the specified user.

In some embodiments, the remedial action includes reporting a first status of the specified user to the enterprise server indicating that the specified user is not physically adjacent to the computer system. In some embodiments, the dedicated browser notifies the enterprise server of security events, including any detected event that causes any of the plurality of security criteria to fail. For example, when another user enters the field of view of the computer system's camera, or a phone or other camera is detected in the field of view of the camera, or a VPN is detected, or the specified user attempts a screenshot, or the specified user leaves their computer without locking it, corresponding events (e.g., events identifying the security issue) are passed from the dedicated browser to the enterprise server so that a security audit (e.g., by the third-party administrator) can be performed at a later time. In some embodiments, the enterprise server provides, to the third-party administrator, a report that includes or summarizes these security events.

In some embodiments, the dedicated browser receives (e.g., prior to accessing the respective webpage), from the enterprise server, information from a user profile of the specified user, wherein the information from the user profile includes the biometric information for the specified user. In some embodiments, the biometric information for the specified user includes a photograph of the specified user. In some embodiments, monitoring whether the specified user is physically adjacent to the computer system includes comparing images obtained by the camera of the computer system to the photograph of the specified user from the user profile to determine that the user using the dedicated browser is the same person as the person in the photograph.

In some embodiments, the information from the user profile includes the identifiers of the set of one or more proxy servers through which the dedicated browser is configured to access the predefined set of one or more webpages (e.g., the user profile includes URLs for the proxy servers). As noted above, in some embodiments, the set of one or more proxy servers may also be based on, e.g., global configurations and/or security group configurations. In some embodiments, the enterprise server determines, at run-time, which configurations apply to the specified user and provides the identifiers of the set of one or more proxy servers based on the configurations that apply to the specified user.

In some embodiments, the information from the user profile includes the list specifying the predefined set of one or more webpages to which the dedicated browser is configured to access (e.g., the user profile includes the specified user's whitelist of webpages). As noted above, in some embodiments, the predefined set of one or more webpages may also be based on, e.g., global configurations and/or security group configurations. In some embodiments, the enterprise server determines, at run-time, which configurations apply to the specified user and provides the list specifying the predefined set of one or more webpages based on the configurations that apply to the specified user.

In some embodiments, the list specifying the predefined set of one or more webpages is designated by a third-party administrator associated with a third-party administrator server, distinct from the enterprise server. In some embodiments, the list specifying the predefined set of one or more webpages is not designated or modifiable by the user (or another user of the same device). In some embodiments, the predefined set of one or more webpages are third-party webpages. In some embodiments, the predefined set of one or more webpages comprises webpages associated with the third-party administrator (e.g., webpages on the third-party administrator's own website). In some embodiments, the third-party administrator defines the global and/or security group configurations discussed above.

In some embodiments, the dedicated browser provides (e.g., without user intervention), to the third-party administrator server, information identifying the specified user that is accessing the respective webpage through the respective proxy server. The third-party administrator server is enabled to: request a log-in status of the specified user from the enterprise server using the information identifying the specified user; and, based on the log-in status (e.g., either “logged-in” or “not logged-in”) of the specified user from the enterprise server, terminate access to the respective webpage at the respective proxy server. In some embodiments, the third-party administrator server detects traffic at the respective webpage from the dedicated browser. To avoid the possibility of spoofing the dedicated browser, the third-party administrator server may verify with the enterprise server that the specified user is logged into the dedicated browser. In some embodiments, the enterprise server has direct knowledge of whether the specified user is logged into the dedicated browser because the enterprise server performed a handshake (e.g., during the initialization described above) with the dedicated browser at runtime (e.g., at which time the user profile information was sent).

In some embodiments the dedicated browser provides (e.g., without user intervention), to the respective proxy server, information identifying the specified user that is accessing the respective webpage through the respective proxy server. The respective proxy server is enabled to: request a log-in status of the specified user from the enterprise server using the information identifying the specified user; and, based on the log-in status of the specified user from the enterprise server, terminate access to the respective webpage at the respective proxy server. In some embodiments, the proxy server detects traffic to the respective webpage from the dedicated browser. To avoid the possibility of spoofing the dedicated browser, the proxy server may verify with the enterprise server that the specified user is logged into the dedicated browser. Thus, in some embodiments, there are multiple security “gates” that can be shut (e.g., by the dedicated browser, by the proxy server, by the third-party administrator) to ensure that unauthorized user's do not access the respective webpage.

In some embodiments, prior to accessing the respective webpage, the dedicated browser receives a link to download the dedicated browser, wherein the link includes an identifier of the specified user (e.g., the specified user clicks on the link to download and install the dedicated browser).

In some embodiments, the dedicated browser is configured to be installed, using the link, on only a single computing system (e.g., once the link has been used, it is no longer valid).

In some embodiments, the dedicated browser is configured to be used, once installed using the link, only by the specified user (e.g., the link is a customized link such that the downloaded browser is preconfigured to access the specified user's profile).

In some embodiments, prior to accessing the respective webpage, multifactor authentication is used to verify the user. In some embodiment, the multifactor authentication comprises a biometric authentication using images and/or video obtained from a second device distinct from the device on which the dedicated browser is running (e.g., a mobile phone, tablet, or the like). In some embodiments, prior to accessing the respective webpage, the dedicated browser performs an initial identity verification, including: communicating, to a mobile device of the specified user that is distinct from the computer system on which the dedicated browser is running, an identifier of the dedicated browser, wherein the identifier of the dedicated browser is used by the mobile device to perform an initial identity verification of the specified user. In some embodiments, communicating the identifier of the dedicated browser (or of the session of the dedicated browser) includes displaying a QR code. The mobile device is then able to scan the QR code to initiate the initial identity verification process. In some embodiments, the initial identity verification process includes comparing images of the specified user obtained by a camera of the mobile device to a photograph of the specified user in the user profile. In some embodiments, the continuous monitoring of whether the specified user is physically adjacent to the computer system using the camera and biometric information for the specified user includes comparing images obtained by the camera of the computer system to the same photograph. However, in some circumstances, the camera of the mobile device will have higher resolution and quality than the camera of the computer system (which may be a webcam), and thus an initial identity verification using the camera of the mobile device adds a layer of security. In some embodiments, the initial identity verification includes a liveness detection (e.g., to make sure that the identity cannot be verified by holding up a photograph of the user to the mobile device's camera). In some embodiments, the identifier of the dedicated browser (or session) is passed using a wireless communications protocol rather than a QR code (e.g., Bluetooth, near-field communication, or the like). In some embodiments, rather than the dedicated browser passing an identifier to the mobile (or other) device, the enterprise server pushes an authentication request to the mobile device (e.g., via an application running on the mobile device). In some embodiments, the multifactor authentication is used in lieu of a password (e.g., the user is not required to enter a password because the user has passed the multifactor authentication, including the biometric identification on the second device, which when coupled with the biometric monitoring using the dedicated browser, results in a very secure session).

Although FIG. 6 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof. Further, in some embodiments, one or more of the operations of the method 600 can be performed in conjunction with any of the operations of the method 700 described with respect to FIGS. 7A-7B, and/or the method 900 described with respect to FIGS. 9A-9B.

FIGS. 7A-7B are schematic diagrams illustrating a method 700 of using an authentication status of user in conjunction with the user attempting to log on to a different third-party system, in accordance with some embodiments. Method 700 provides an example of communication between various devices shown and described with respect to FIG. 1, and the order of operations between them. Note, however, method 700 is just one example of the communication between the various devices, while other examples are described through this specification and/or will be apparent to one of skill in the art.

In method 700, a server system receives a request (702) (e.g., from a client device) to initiate a secure session. In some embodiments, the request is to initiate a secure session at a dedicated browser (e.g., the dedicated browser initiated by operation 506 in FIGS. 5A-5B). In some embodiments, the request includes a first set of contextual data from a user interface presented by the client device.

In some embodiments, a client device sending the request is one of a laptop computer, an electronic mobile device (e.g., a phone, tablet, wearable electronic device, and/or artificial-reality glasses). In some embodiments, the request to initiate the secure session is received from a different electronic device than a client device (e.g., third-party administrator server 110, as discussed with respect to operation 502 in FIG. 5A).

Continuing with method 700, the server system initiates (704) the secure session (e.g., at a client device). In some embodiments, initiating the secure session is distinct from initiating a dedicated browser as described with respect to FIG. 5A (e.g., operation 506). In some embodiments, the server system causes the client device to initiate the session based on receiving authentication data from an application (e.g., a dedicated browser) running on the client device, and determine, using the authentication data from the application running on the client device, the authentication status of the user.

In some embodiments, initiating the secure session includes multiple operations (e.g., sending the user a link to download the dedicated browser as in operation 504, and/or any of the other operations 506, 508, 510, 512, and 514 discussed in FIG. 5A). In some embodiments, the operations performed in order to initiate the secure session can be based in part on the interactions that the user and/or client device has access to in conjunction with the secure session being initiated, which can be configurable for each instance of the dedicated browser and/or the secure session.

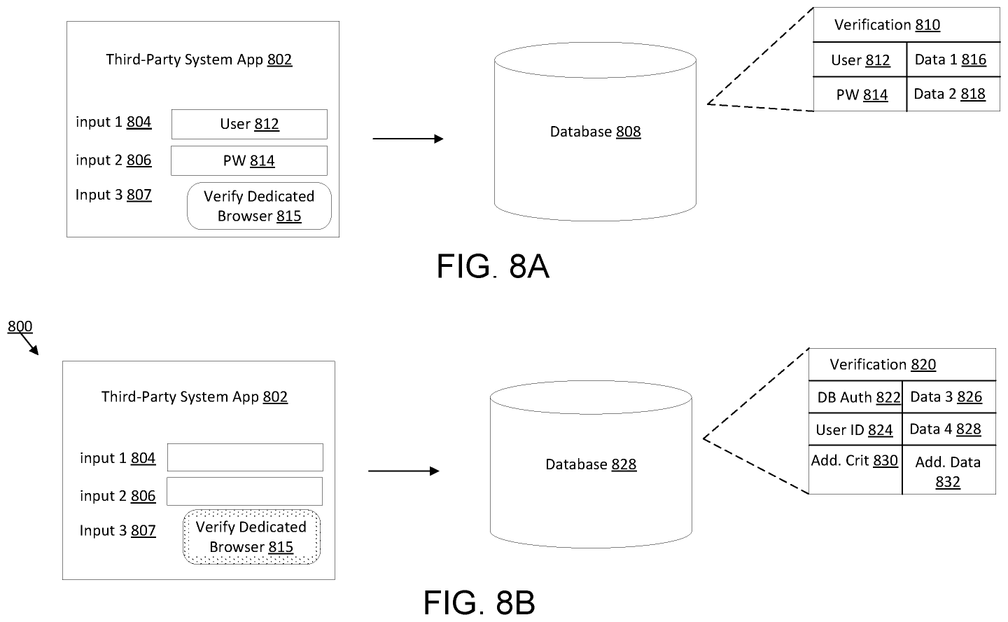

Continuing with method 700, while the secure session of the client device is active, the server system determines that the user is attempting (706) to log-in from the client device to a third-party system (e.g., another application distinct from a dedicated browser such as a file-management system). For example, the secure session can be configured to be operated at a dedicated browser, and the third-party application can be an application configured to be operated from a system level (an operating system level) of the client device. As discussed with respect to FIGS. 8A-8B, the user's attempt to log-in to the third-party system can include providing inputs to a user interface associated with an application (e.g., an application 802) of the third-party system. In some embodiments, the attempt to log on to the third-party system is made within the dedicated browser associated with the secure session.

In some embodiments, the third-party administrative server 110 requests (707) the user's authentication status from the enterprise server 108. In some embodiments, the enterprise server 108 repeatedly sends the user's authentication status to the third-party administrator server 110. In some embodiments, the third-party administrator server 110 also requests or otherwise receives an identifier of the user or the client device (e.g., user identifier 824 in FIG. 8B). In some embodiments, as shown by the operations 522 and 524 in FIG. 5B, the third-party administrator server requests the user's authentication status to be requested by a proxy server (e.g., the proxy server 114a) to, for example, prevent spoofing.

Based on the user attempting to log on to the third-party administrative server 110, the server system communicates (708) the authentication status of the user of the client device to the third-party administrative server 110. That is, the server system can be configured to provide single sign-on operations to the client device based on the user's authentication status at the secure session. In some embodiments, the authentication status communicated by the server system is an additional authentication that must be performed for the user to be authenticated by the third-party system (e.g., the authentication status of the user of the client device is one factor of a multi-factor authentication protocol). In some embodiments, receiving the authentication status from the server system allows the third-party administrative server to forgo one or more authentication operations (such as having the user enter a user name and password or performing a conventional multifactor authentication). Thus, in some embodiments, in accordance with a determination that an authentication status has been received from the server system, the third-party administration server forgoes one or more authentication operations; and in accordance with a determination that an authentication status has not been received from the server system, the third-party administrative server performs the one or more authentication operations.

In some embodiments, before or after communicating the authentication status of the user of the client device to the third-party system, the server system receives (710) another authentication status of the client device. The other authentication status can be associated with the third-party system, in accordance with some embodiments. In some embodiments, the other authentication status includes an identifier of a client device, and/or an authentication status of the user associated with the request (e.g., a media access control (MAC) address). That is, the third-party system can verify that the authentication status communicated by the server system is associated with the same user that is attempting to log on to the third-party system.

Continuing with method 700, in some embodiments, based on receiving the other authentication status, the server system causes (712) an identity provider chain to be created (which can optionally occur at the enterprise server 108, and/or the identity provider server 701) that includes the authentication status at the secure session and the other authentication status associated with the third-party system. In some embodiments, the identity-provider chain is stored at the enterprise server 108. In some embodiments, it is stored at a separate and distinct identity provider server 701. In some embodiments, the identity provider chain is stored at the user's client device. In some embodiments, the identity provider chain is stored at a proxy server (e.g., the proxy server 114a in order to prevent spoofing).

In some embodiments, the identity provider server is configured to persistently monitor (e.g., continuously poll) (714) the authentication status and the other authentication status. In some embodiments, the storer of the identity provider chain (e.g., the identity provider server 701) polls the authentication status and the other authentication status at discrete intervals. In some embodiments, the identity provider server 701 polls one of the respective authentication statuses more frequently, which can be based on which authentication status is serving as the primary factor of authentication. For example, the identity provider server 701 can poll the authentication status associated with the secure session every half-second, and can poll the authentication status associated with the enterprise server every five seconds, ten minutes, or not at all.

Continuing with method 700, the identity provider server can detect (715) a change in the authentication status of the secure session and/or the other authentication status of the third-party administrator server 110. Continuing with method 700, the server system can receive an indication (716) from the identity provider server that the identity provider chain has detected a change to one or both of the authentication status of the secure session and the other authentication status of the third-party system.

In accordance with determining that the identity provider server has detected a change of the authentication status or the other authentication status, the server system can cause (718) an operation (e.g., a remedial action) of a predefined set of operations to be performed at the secure session or the other application. In some embodiments, the remedial action can be dependent on whether the change is to the authentication status of the secure session, or the other authentication status of the third-party system. For example, the client device's authentication status associated with secure session can be a primary factor of authentication, and therefore controls the client device's access to both the secure session and access to the third-party system. Therefore, the server system can cause the third-party application to be terminated or otherwise restricted based on a detected change to the authentication status associated with the secure session.

Continuing with method 700, in some embodiments, while the secure session is active, the other application associated with the third-party system is terminated (720). That is, the user logs off, or they don't use the other application for an amount of time that causes the third-party system to log them off automatically. In some embodiments, after the application associated with the third-party system is terminated, the user attempts (722) to re-access the application associated with the third-party system.

Based on the user attempting to re-access the application associated with the third-party system, the server system automatically, without further intervention by the user, authenticates (724) the user at the application associated with the third-party system. In some embodiments, the authentication is performed based on the user's authentication status for the secure session. In other words, the authentication status associated with the secure session can be used as a primary factor of authentication to one or more of a suite of applications that the user access regularly (e.g., for work), and can be used in a single sign-on protocol to allow the user to navigate between the applications they use regularly more based on the authentication status associated with the secure session (e.g., based on being logged in to the dedicated browser). In some embodiments, the request to re-access the other application must occur within a predefined period of time (e.g., one minute, one hour, one hundred days, etc.) in order for single-sign on operations to be performed at the other application. In some embodiments, the server system causes the secure session to perform an additional authentication (e.g., a biometric verification, detecting a user-performed hand gesture, etc.) as part of the single-sign on process.

In some embodiments, while the secure session is active, the user requests (726) to the third-party system, to access restricted content (e.g., higher-level security content, confidential and/or attorney-client privileged information, access to view and/or modify database and/or server code, etc.) at the third-party system. Based on the user's request to access the restricted content, the server system causes the secure session to perform (728) an additional authentication (e.g., of proper access conditions) at the secure session. In some embodiments, the additional authentication includes a one-time biometric verification (e.g., activating a camera to determine the user is adjacent to a client device).

In some embodiments, the device is configured to track eye movement of the user, and the one-time biometric verification includes a tracked eye movement of the user corresponding to user verification settings. In some embodiments, the additional authentication includes verifying one or more access conditions of the secure session. For example, if the user is in a public location, on a public network connection, and/or if there is someone other than the user in view by a camera of the computing system 102. In some embodiments, the user performs a hand gesture to verify the user's identity. In some embodiments, the hand gesture corresponds to a predefined authentication gesture that the user has previously configured to be the respective hand gesture used to verify the user's identity.

In some embodiments, the one or more access conditions include at least one of (i) an identifier of a network from which the user is accessing the secure session, (ii) a location of the user while the user is accessing the secure session, and (iii) one or more aspects of physical surroundings of the user. In some embodiments where the secure session is associated with a dedicated browser (e.g., the dedicated browser in FIGS. 5A-5B), the additional authentication includes receiving one or more of a cookie and a session token from the secure session to the other application.

Although FIGS. 7A-7B illustrate a number of logical stages in a particular order, stages which are not order dependent may be reordered and other stages may be combined or broken out. Some reordering or other groupings not specifically mentioned will be apparent to one of ordinary skill in the art, so the ordering and groupings presented herein are not exhaustive. In some embodiments, some or all of the operations described with respect to FIGS. 7A-7B can be performed in conjunction with one or more operations of the method 500 described with respect to FIGS. 5A-5B, operations of the method 600 described with respect to FIG. 6, and/or the operations of the method 900 with respect to FIGS. 9A-9B.

FIGS. 8A-8B are control flow diagrams illustrating alternative or additive methods (e.g., methods that are part of multi-factor authentication protocol) for authenticating a user at a computing system 800 (which can include some or all of the components of the third-party administrative server 110, the computing system 102, the enterprise server 108, etc.), in accordance with some embodiments. In both of FIGS. 8A-8B, the user has already initiated a secure session (e.g., at a dedicated browser). In other words, the user can have performed one or more of the operations described with respect to FIGS. 5A-5B for logging into a dedicated browser. In some embodiments an enterprise server associated with the dedicated browser, or the dedicated browser itself, receives an identifier of the client device that the user is accessing the secure session from, and/or an identifier of the user themself.

In FIG. 8A, a user is presented with a user interface (e.g., a log-in screen) for an application 802 of the third-party system. FIG. 8A illustrates a situation in which a user provides inputs (e.g., a username and password) in order to access the third-party system. The user interface allows the user to provide inputs. The user has entered values (e.g., a user 812, a password 814) at respective inputs (e.g., an input 804, an input 806) of the user interface. When the user attempts to log-in, the database 808 compares the user-entered username 812 against a first data item 816 and compares the user-entered password 814 against a second data item 818. If the respective values match the corresponding data items, then the user can be logged-in to the third-party system, in accordance with some embodiments. In some embodiments, the control flow illustrated by FIG. 8A occurs in addition to the control flow described below with respect to FIG. 8B (e.g., the computing system 800 can utilize a multi-factor authentication model that includes both steps to log on to the third-party system).

In FIG. 8B, the user is presented with the same user interface for the application 802. FIG. 8B illustrates a situation in which the third-party system forgoes one or more authentication operations on the basis of receiving an authentication status of a secure session. Instead of entering values, the user presses the button input 815 for verifying the user's authentication status at a dedicated browser. In some embodiments, the authentication status is associated with a secure session at the dedicated browser. In some embodiments, while the secure session is active, the user is not presented with such a user interface when attempting to log on to the application 802, and the computing system 800 automatically initiates this control flow without further user input. The user's authentication status is checked by a database 828, which can be the same database 808, or a different one. In some embodiments, a distinct function is executed by the enterprise server 800 instead of accessing the database 828.

The database 828 checks if the authentication status 822 of the user matches a third data item 826 (e.g., a status code associated with an authenticated user). In some embodiments, the database 828 also compares a user identifier 824 (e.g., a MAC address, a device ID, and the like) to a fourth data item 828, which can be an identifier of the client device or the user that was previously stored by the dedicated browser during initiation or operation of the secure session. In some embodiments, the database 828 compares one or more additional criteria 830 about the user to one or more additional data items 832. In some embodiments, the additional criteria 830 depend on whether the user is attempting to access restricted content, and/or a higher-level of access (administrative access) than general access.

FIGS. 9A-9B illustrate a flow diagram of a method 900 of providing authentication to a user in conjunction with a secure computer session at a dedicated browser, in accordance with some embodiments. Method 900 may be performed at a server system (902) initiating a secure session of an application (e.g., a dedicated browser configured to be downloaded by a user based on a request to the server system). In some embodiments, the server system is executing on a computer system that includes one or more processors (e.g., CPU(s) 202, FIG. 2) and memory (e.g., memory 212, FIG. 2). In some embodiments, the server system is configured to provide or otherwise facilitate operations of a dedicated browser (e.g., dedicated browser 234) at a client device.

In initiating the secure session of the application, the server system (i) receives (904), from a client device, a first set of contextual data (e.g., authentication data, configuration data, biometric data, data related to a user's physical surroundings) from a user interface presented by the client device (e.g., a textual prompt within a browser user interface, an input for providing a biometric aspect of the user's identity, a microphone, etc.), and (ii) determines (906), using the first set of contextual data from the application running on the client device, a first authentication status (e.g., logged-on, not logged on, error status, “404 status”, etc.) of a user for the secure session.

As described, front-end operations of a browser are any operations that are performed using the scripts (e.g., JavaScript, HTML, and/or CSS) that are locally deployed within a webpage. In some embodiments, all of the front-end operations may occur without performing a request to any server or other computing system that is remote from the body of the webpage. In some embodiments, the authentication status is processed as an error by front-end operations of a browser associated with the secure session, and received by the server as a non-error status (e.g., a non-error response that includes data indicating the front-end error status).

While (908) the secure session of the client device is active, the server system determines that the user is attempting to log on, from the client device, to a third-party system. In some embodiments, the determination that the secure session is still active is based on detecting that a same session identifier (e.g., a cookie stored in local data) is present within the local data of the webpage. In some embodiments, the session identifier includes information about the user (e.g., a MAC address).

In some embodiments, the third-party system requests the authentication status from the server system (e.g., operation 707 in FIG. 7A). In some embodiments, the third-party system accesses the authentication directly from the client device. In some embodiments, the authentication status communicated by the server system is an additional authentication that must be performed for the user to be authenticated by the third-party system (e.g., the authentication status of the user of the client device is one factor of a multi-factor authentication protocol).

In some embodiments, based on a determination that the authentication status is a first status (e.g., indicating that the user has been authenticated), the third-party system forgoes requiring one or more other forms of authentication (e.g., the username 812 and/or the password 814 in FIG. 8A). For example, in accordance with a determination that the client device has an active secure session, the third-party system forgoes requiring a username and/or password from the client device, in accordance with some embodiments.

The server system communicates (910) the authentication status of the user, for the secure session, to the third-party system. For example, the operation 708 shown in FIG. 7A shows the enterprise server 108 communicating an authentication status of the user of the client device to the third-party administrator server 110. In some embodiments, the authentication status of the user of the client device is provided to the third-party system automatically, without further intervention, based on the user of the client device attempting to log in to the third-party system (e.g., via one of the control flows described with respect to FIGS. 8A-8B). In some embodiments, the authentication status of the user of the client device is provided to the third-party system based on the secure session being initiated (e.g., when the authentication status of the of the user is determined for the secure session). For example, the authentication status could be provided from the enterprise server 108 to the third-party administrator server 110 between the operations 702 and 706 in FIG. 7A.

The server system determines (912) a second authentication status of the user of the client device, using a second set of contextual data, distinct from the first set of contextual data, from a second application running on the client device, associated with the third-party system. In some embodiments, the first application corresponds to a dedicated browser, and the second application is a web application that is configured to be executed within the dedicated browser corresponding to the first application. In some embodiments, the second authentication status includes an identifier of a client device, and/or an identifier of the user associated with the request (e.g., a media access control (MAC) address, a user and/or device associated with an active device profile, etc.). In other words, the third-party system can verify that the authentication status communicated by the server system is associated with the same user that is attempting to log on to the third-party system.

In some embodiments, the server system creates (914) an identity provider chain that includes the first authentication status and the second authentication status. As described herein, an identity provider chain is a data object (e.g., an entry in a database, a JavaScript Object Notation (JSON) object, an extensible markup language (XML) document, etc.) that includes a plurality of authentication statuses for a single user. In some embodiments, a dedicated browser is configured to create the identity provider chain and/or store the chain locally in addition to or as an alternative to storing the chain at a server. In some embodiments, the identity provider chain is stored in a plurality of locations (e.g., a server system, a client device, a third-party administrator server, and/or a server configured to store and perform operations related to the identity provider chain (e.g., the identity provider server 701 in FIGS. 7A-7B). Different versions of the identity provider chain can be compared to verify the content of the identity provider chain. That is, the plurality of locations storing the identity provider chain can serve as a distributed ledger. The single user can be associated with a plurality of client devices, and a set of devices associated with the user can also be stored in the identity provider chain.

In some embodiments, the identity provider chain and/or associated operations include one or more priority heuristics (e.g., an order of operations) for verifying authentication statuses. An identity provider chain can be used to simultaneously authenticate a user for a plurality of applications, including a predefined set of third-party applications. In some embodiments, the identity provider chain is stored at an identity provider server (e.g., a database server), that is configured to perform operations for creating, updating, reading, and/or deleting data objects corresponding to respective identity provider chains. In some embodiments, the identity provider chain is created automatically, and without further instruction from the user. In some embodiments, a prompt is presented to the user for creating the identity provider chain (e.g., the button input 815 shown in FIGS. 8A-8B).

In some embodiments, creating (916) the identity provider chain includes associating an aspect of the user's identity (e.g., biometric information detected by one or more sensors disposed at the client device) with a credential associated with the third-party system. In some embodiments, an imaging sensor is activated based on a determination to create an identity provider chain. In some embodiments, the aspect of the user's identity can be used as a proxy for one or more of the user's credentials (e.g., for use in accessing a third-party application). For example, an identification of a user, determined via facial recognition applied to an image captured by the image sensor, can be used as an alternative to the user's manually entered username and/or password that is associated with the user's identity at the third-party application.

In some embodiments, based on (918) the identity provider chain including the first authentication status and the second authentication status, the server system persistently monitors, via the server system (e.g., via polling), (i) the first application for changes to the first authentication status, and (ii) the second application for changes to the second authentication status. For example, the identity provider server can poll the authentication status associated with the secure session every half-second, and can poll the authentication status associated with the second application (e.g., a third-party application) every five seconds, ten minutes, or not at all. In some embodiments, the server system monitors the first application and the second application at different frequencies based on the respective priorities of the authentication statuses (e.g., whether each respective authentication status is a primary factor of authentication, a secondary factor of authentication, a tertiary factor of authentication, etc.). In some embodiments, different techniques for monitoring the first and second authentication statuses can be used in conjunction with verifying the identity provider chain. For example, if a user is logged out or requesting elevated access to a third-party application, thereby causing a change to the respective authentication status associated with the third-party application, the server system causes a one-time biometric verification to be performed at the dedicated browser, in accordance with some embodiments.

In some embodiments, based on (920) an indication (e.g., via the identity provider chain) that one of (i) the first authentication status and (ii) the second authentication status has changed (e.g., the respective authentication status has a different value as received by the server), the server system causes an operation (e.g., of a predefined set of operations) to be performed at the first application or the second application. In some embodiments, the operation is performed directly in response to one of the first authentication status or the second authentication status changing. In some embodiments, the operation is performed based on one or more remedial action criteria being satisfied, which can include one or both of the first and second authentication statuses. In some embodiments, the operation is performed automatically without additional input and without allowing a user of the client device to intervene with the operation that corresponds to the remedial action. That is, the user cannot prevent the operation from occurring or otherwise adjust the way that the operation is performed.

In some embodiments, the indication includes an operating-system-level (OS-level) notification, that is provided outside of the first application and the second application, at the client device. For example, the first application (e.g., a dedicated browser) is configured to detect that a user has taken a screenshot of a webpage, based on monitoring user interactions with the client device. As a result of detecting that the user has taken a screenshot, the first application can cause a change to the user's authentication status at the first application. In some embodiments, based on the server system receiving the indication that the first authentication status has changed, the server system instructs the client device to perform an OS-level operation (e.g., operating system specific operations) that restrict the user's access to some or all local files at the client device (e.g., all files that were saved during the secure session).

In some embodiments, the server system is configured to cause a predefined set of operating-system-specific operations (e.g., log-out operations, shut-down operations, access-blocking operations) at the client device, which can be performed using operating-system-specific implementations. In some embodiments, the server system includes an API for communicating instructions with operating systems of respective client devices.

In some embodiments, one of the first authentication status or the second authentication status is a primary factor of authorization (e.g., a ground truth regarding the user's authentication status), and the second authentication status is a secondary factor of authentication. In some embodiments, a biometric identification of the user is a tertiary factor of authentication (e.g., as part of a three-factor authentication model). In some embodiments, the primary factor of authentication is the first authentication that is detected by the identity provider chain (e.g., as part of a priority heuristic). In some embodiments, the server system causes an identifier associated with the primary factor of authentication to be stored at a dedicated browser running at the client device. In some embodiments, the identifier associated with the primary factor of authentication is stored at the dedicated browser while the server system is configuring the dedicated browser to be provided to the user. In some embodiments, the identifier associated with the primary factor of authentication is stored at the dedicated browser so as to be inaccessible to the user of the client device, but accessible to the third-party system (e.g., via an authorized API request).

In some embodiments, based on (922) the indication that the first authentication status has changed at the secure session, the server system causes a first remedial action (e.g., an OS-level action) to be taken. For example, based on an indication that the user's authentication status has changed at a dedicated browser, the server system can cause the browser to be terminated, and/or become visually obscured so to prevent the user from accessing the information therein.

In some embodiments, the first remedial action includes (924) terminating access, at the client device, to the second application associated with the third-party system. That is, the server and/or the client device can be configured to terminate access to the second application based on determining that the user's authentication status has changed at the secure session of the dedicated browser. In some embodiments, the first remedial action is an OS-level action at the client device. In some embodiments, the first remedial action is based on a determination that the user is not physically adjacent to the client device. In some embodiments, the first remedial application is taken at the second application.

In some embodiments, in accordance with (926) a second indication that the second authentication status has changed at the second application, the server system causes a second remedial action to be taken, wherein the second remedial action is distinct from the first remedial action. That is, the second remedial action includes one or more operations that are not performed by the first remedial action, and/or the first remedial action includes one or more operations that are not performed by the second remedial action. In some embodiments, the secure session is configured to operate at a dedicated browser, and the first remedial action is an OS-level remedial action. In some embodiments, the second application is at one of a tab of the dedicated browser, a different browser, and/or a desktop application, and the second remedial action is an application-level remedial action (e.g., shutting down and/or closing the tab of the browser).

In some embodiments, the server system is configured to receive (928) a request from the user to access a restricted content item (e.g., an access permission to a document (e.g., edit access), a downloadable content item, protected health information (PHI) and/or an attorney-client privileged content item) at the second application associated with the third-party system. In some embodiments, the restricted content is one or more operations associated with a higher level of access control (e.g., the ability to create and/or modify a database).

In some embodiments, based on (930) the request for the restricted content item at the second application, the server system causes an additional authentication operation (e.g., a one-time biometric authentication, such as a fingerprint scan, a facial scan via an imaging sensor, and/or an aspect of a currently displayed webpage detected via an iframe element and/or a web beacon) to be performed by the secure session. In some embodiments, the additional authentication operation is performed by the second application.

In some embodiments, the additional operation includes (932): (i) a verification of a biometric aspect of the user (e.g., a facial profile detected by an imaging sensor, a gesture profile), (ii) A network identifier associated with a communication network being used in conjunction with the secure session, (iii) a physical location, and/or (iv) an aspect of the user's physical surroundings (e.g., whether the user and/or another viewer has a different electronic device nearby (e.g., a mobile phone capable of capturing an image of a display of the client device)). In some embodiments, the physical location includes a position within a space relative to the client device. In some embodiments, the physical location is detected via a global positioning system (GPS).

In some embodiments, the secure session is (934) associated with a dedicated browser (e.g., a modified browser that is restricted to accessing only a predefined set of webpages), and the additional authentication operation includes providing, from the secure session to the second application, (i) a cookie, or (ii) a session token. That is, the additional authentication is produced by a web application. In some embodiments, the additional authentication is based on an iframe and/or web beacon element. In some embodiments, the authentication is based on a JavaScript web token.

In some embodiments, while (936) the secure session is active, after the application associated with the third-party system, distinct from the secure session, has been terminated and subsequently re-accessed by the user, the server system automatically (e.g., without further intervention by the user), authenticates the user at the application associated with the third-party system. In some embodiments, the authentication is performed entirely by front-end operations of a webpage (e.g., of a webpage within a browser that is hosting the secure session).

In some embodiments, initiating the secure session of the client device includes accessing a dedicated browser that is configured to (i) based on authenticating an identification of the user using at least a biometric verification, activate the secure session at the dedicated browser, (ii) monitor, using a camera, that the user remains present during the secure session while the secure session is active, and (iii) while the camera is monitoring whether the user is remaining present during the secure session, terminate the secure session in response to determining that the user is not physically adjacent to the client device.

In some embodiments, some or all of the operations described with respect to FIGS. 9A-9B can be performed in conjunction with one or more of the operations of the method 500 described with respect to FIGS. 5A-5B, the operations of the method 600 described with respect to FIG. 6, and/or the method 700 with respect to FIGS. 7A-7B.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

1. A method, comprising:
at a dedicated browser executing on a computer system comprising a camera and one or more processors and memory, wherein the dedicated browser is restricted to accessing a predefined set of one or more webpages:
accessing a respective webpage of the predefined set of one or more webpages through a respective proxy server of a set of one or more proxy servers;
while accessing the respective webpage through the set of one or more proxy servers, monitoring whether a specified user is physically adjacent to the computer system using the camera and biometric information for the specified user; and
in accordance with a determination that the specified user is not physically adjacent to the computer system, taking a remedial action.

2. The method of claim 1, wherein the remedial action includes terminating access to the respective webpage.

3. The method of claim 1, wherein:
the remedial action includes displaying a countdown timer indicating a length of time before access to the respective webpage is terminated; and
the method further includes:
at completion of the countdown timer, terminating access to the respective webpage.

4. The method of claim 1, further comprising:
receiving, from an enterprise server:
a list specifying the predefined set of one or more webpages to which the dedicated browser is configured to access; and
identifiers of the set of one or more proxy servers through which the dedicated browser is configured to access the predefined set of one or more webpages.

5. The method of claim 4, further comprising, receiving, from the enterprise server, a temporary authentication credential that allows the dedicated browser to access webpages from the predefined set of one or more webpages through the set of one or more proxy servers.

6. The method of claim 4, wherein the remedial action includes reporting a first status of the specified user to the enterprise server indicating that the specified user is not physically adjacent to the computer system.

7. The method of claim 4, further including:
receiving, from the enterprise server, information from a user profile of the specified user, wherein the information from the user profile includes the biometric information for the specified user.

8. The method of claim 7, wherein the information from the user profile includes the identifiers of the set of one or more proxy servers through which the dedicated browser is configured to access the predefined set of one or more webpages.

9. The method of claim 7, wherein the information from the user profile includes the list specifying the predefined set of one or more webpages to which the dedicated browser is configured to access.

10. The method of claim 4, wherein the list specifying the predefined set of one or more webpages is designated by a third-party administrator associated with a third-party administrator server, distinct from the enterprise server.

11. The method of claim 10, further including, providing, by the dedicated browser, to the third-party administrator server, information identifying the specified user that is accessing the respective webpage through the respective proxy server;
wherein the third-party administrator server is enabled to:
request a log-in status of the specified user from the enterprise server using the information identifying the specified user; and,
based on the log-in status of the specified user from the enterprise server, terminate access to the respective webpage at the respective proxy server.

12. The method of claim 4, further including, providing, by the dedicated browser, to the respective proxy server, information identifying the specified user that is accessing the respective webpage through the respective proxy server;
wherein the respective proxy server is enabled to:
request a log-in status of the specified user from the enterprise server using the information identifying the specified user; and,
based on the log-in status of the specified user from the enterprise server, terminate access to the respective webpage at the respective proxy server.

13. The method of claim 1, further comprising:
prior to accessing the respective webpage, receiving a link to download the dedicated browser, wherein the link includes an identifier of the specified user.

14. The method of claim 13, wherein the dedicated browser is configured to be installed, using the link, on only a single computing system.

15. The method of claim 13, wherein the dedicated browser is configured to be used, once installed using the link, only by the specified user.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

29. A computer system, comprising:
a camera;
one or more processors; and
memory, wherein the memory stores one or more programs including a dedicated browser that is restricted to accessing a predefined set of one or more webpages, the dedicated browser including instructions for:
accessing a respective webpage of the predefined set of one or more webpages through a respective proxy server of a set of one or more proxy servers;
while accessing the respective webpage through the set of one or more proxy servers, monitoring whether a specified user is physically adjacent to the computer system using the camera and biometric information for the specified user; and
in accordance with a determination that the specified user is not physically adjacent to the computer system, taking a remedial action.

30. (canceled)

31. A non-transitory computer-readable storage medium storing one or more programs for execution by a computer system with a camera, the one or more programs including a dedicated browser that is restricted to accessing a predefined set of one or more webpages, the dedicated browser including instructions for:
accessing a respective webpage of the predefined set of one or more webpages through a respective proxy server of a set of one or more proxy servers;
while accessing the respective webpage through the set of one or more proxy servers, monitoring whether a specified user is physically adjacent to the computer system using the camera and biometric information for the specified user; and
in accordance with a determination that the specified user is not physically adjacent to the computer system, taking a remedial action.

32. (canceled)
